(19) United States
(12) Patent Application Publication
(10) Pub. No.: US 2004/0063598 A1
(43) Pub. Date: Apr. 1, 2004

(54) Mechanically stable, liquid formulation washing, rinsing or cleaning agent doses

(76) Inventors: Hans-Juergen Riebe, Solingen (DE); Rainer Geberzahn, Grevenbroich (DE)

Correspondence Address: HENKEL CORPORATION, THE TRIAD, SUITE 200, 2200 RENAISSANCE BLVD., GULPH MILLS, PA, 19406, US

(21) Appl. No.: 10/362,006

(22) PCT Filed: Aug. 8, 2001
(86) PCT No.: PCT/EP01/09173

(51) Int. Cl. C11D 17/00

(52) U.S. Cl. 510/293; 510/295; 510/296; 510/438

(57) ABSTRACT

The invention relates to a washing, rinsing or cleaning agent dose comprising a fully or partially water-soluble coating in the form of a capsule, a ball or a bag. Said coating completely surrounds a liquid-based formulation of at least one washing, rinsing or cleaning active ingredient having a crushing resistance of >1 N at 23° C. The invention also relates to a method for producing one such washing, rinsing or cleaning agent dose, in addition to a method for washing, rinsing or cleaning using said washing, rinsing or cleaning agent dose.

This invention relates to mechanically stable portions of liquid laundry detergents, dishwashing detergents or cleaning compositions. More particularly, the present invention relates to portions of laundry detergents, dishwashing detergents or cleaning compositions in the form of formulations which are liquid during production and packaging and which undergo an increase in viscosity with time, with the result that formulations accommodated in an envelope are mechanically stable by virtue of their thixotropic or pseudoplastic behavior.

Relatively high-viscosity detergents/cleaners and cosmetics have become increasingly available in recent years, products of gel-like consistency being particularly favored by consumers. In the field of liquid detergents, relatively high viscosity gel-like products have the advantage that less nonaqueous solvent can be used in their production and that the resulting product can be applied to the laundry stains alone without running. Conventional liquid detergents based on aqueous formulations are normally converted into relatively high viscosity products by the use of thickeners. Examples of such thickeners are agar agar, carrageen, tragacanth, gum arabic, alginates, pectins, polyoses, guar gum, locust bean gum, starch, dextrins, gelatin, casein, carboxymethyl cellulose and cellulose ethers, hydroxyethyl and hydroxypropyl cellulose and the like, gum ethers, polyacrylic and polymethacrylic compounds, vinyl polymers, polycarboxylic acids, polyethers, polyimines, polyamides, polysilicic acids, clay minerals, such as montmorillonites, zeolites and silicas. The use of these thickeners for increasing viscosity in various liquids has been known for some time. The use of polymers in liquid detergents is also well-known.

The incorporation of thickeners, such as those mentioned above for example, in liquid detergents only leads to stable gels beyond certain surfactant contents. Liquid detergents with surfactant contents below 35% by weight show phase separation or agglomeration after only a few days which is reflected in an opacity (“clouding”) of the formulation. In addition, the viscosity of the products in question decreases, in some cases drastically, during storage. Since gel formation normally only occurs at surfactant contents above 35% by weight, high surfactant contents are therefore essential. Since relatively high viscosity liquid detergents are generally marketed in transparent bottles to emphasize their aesthetic features, the thickeners used also have to be stable to light because otherwise the polymers would be vulnerable to radical decomposition which would be reflected in destruction of the product color and—again—in unwanted “clouding”.

Liquid detergents with viscosities of 500 to 20,000 mPas and preferably 2,000 to 10,000 mPas, in which lamellar surfactant droplets are dispersed in an aqueous electrolyte phase, are described in European patent application EP-A 691 399 (Colgate). These detergents contain 10 to 45% by weight of surfactant(s), at least one builder and 0.01 to 5% by weight of a mercapto-end-capped polymer with an average molecular weight of 1,500 to 50,000 gmol⁻¹.

The use of boron compounds in water-based liquid detergents is described in EP-A 381 262 (Unilever). These liquid detergents contain boron compounds and a polyol as an enzyme stabilizing system for a mixture of proteolytic and lipolytic enzymes, preferred stabilizing systems consisting of a sorbitol/borax mixture. There is no mention in the document in question of the viscosity and stability of the liquid detergents.

Liquid water-based detergent concentrates which retain or increase their viscosity on dilution with water are described in EP-A 724 013 (Colgate). This effect is achieved by the use of two surfactants differing in their resistance to electrolytes and by the addition of a dissolved electrolyte, the concentrate having a viscosity of less than 2,500 mPas and losing its micellar structure on dilution with water in favor of the formation of a lamellar phase.

International patent application WO 96/01305 (Unilever) describes a water-based cleaner and liquid detergent which forms a microemulsion with particle sizes of 10 to 100 nm on dilution with at least twice the quantity of water. The detergent/cleaner contains 20 to 70% by weight of water, 15 to 40% by weight of a surfactant system containing at least one nonionic surfactant from the group of alkoxylated alcohols and no more than 20% by weight of anionic, cationic, amphoteric or zwitterionic surfactant, 5 to 30% by weight of solvent and 5 to 20% by weight of water-insoluble oil.

None of the cited publications is concerned with the problem of providing portioned, relatively high viscosity liquid detergents which guarantee a stable viscosity, do not lead to agglomeration (“clouding”) or phase separation within a portion and keep their color stability under the influence of light.

Water-based, high-viscosity liquid laundry detergents in bulk form containing surfactants and other typical detergent ingredients and a thickening system of polyurethanes or modified polyacrylates, a boron compound and one or more complexing agents, more particularly low molecular weight hydroxycarboxylic acids, are described in WO 99/28430. Portioned laundry detergents, dishwashing detergents or cleaners with thixotropic or pseudoplastic flow behavior of the washing-, dishwashing- or cleaning-active components present therein are not mentioned in that document.

Water-based, high-viscosity liquid laundry detergents in bulk form containing surfactants and other typical detergent ingredients and a thickening system of a polymeric thickener or swelling agent, a boron compound and one or more complexing agents, more particularly low molecular weight hydroxycarboxylic acids, are described in WO 99/27051. Portioned laundry detergents, dishwashing detergents or cleaners with thixotropic or pseudoplastic flow behavior of the washing-, dishwashing- or cleaning-active components present therein are not mentioned in that document.

WO 96/10072 and WO 96/10073 (Procter & Gamble) describe surfactant preparations for treating heavily soiled laundry in the form of a stable suspension of a solid, substantially insoluble particulate material of an inorganic peroxy bleaching agent and an anionic surfactant in a nonaqueous liquid phase of a fatty alcohol ethoxylate as nonionic surfactant and a water-free organic solvent of low polarity and a process for the production of this surfactant preparation in which the solid components are mixed into an intensively agitated mixture of the liquid components. For a water content of the suspension of <5% by weight, the preparations are said to have a viscosity of 300 to 5,000 cps (Brookfield; #5 spindle, 50 r.p.m.) although there is no mention of non-newtonian behavior of the preparations.

EP-A 0 738 778 (Procter & Gamble) discloses nonaqueous liquid laundry detergent preparations in the form of stable suspensions of solid particles of bleaching agents, bleach activators, alkalis, builders and anionic surfactants in nonaqueous mixtures of anionic surfactants (alkali metal or alkanolamine alkyl polyalkoxylates) and nonionic surfactants (polyhydroxyfatty acid amides) and organic diluents (alcohol alkoxylates and low-polarity organic solvents). WO 97/00938 (Procter & Gamble) describes nonaqueous liquid laundry detergent preparations in the form of stable dispersions of bleaching agents (for example peroxy bleaching agents) and optionally bleach activator and organic builders in nonaqueous mixtures of alkali metal salts of alkyl benzenesulfonates, fatty alcohol ethoxylates and nonpolar organic solvents. For a water content of the suspension of <5% by weight, the preparations are said to have a viscosity of 300 to 5,000 cps (Brookfield; #5 spindle, 50 r.p.m.) although there is no mention of non-newtonian behavior of the preparations.

WO 97/00936 and WO 97/00937 (Procter & Gamble) describe nonaqueous (<5% by weight water) surfactant preparations in the form of liquids, gels or pastes containing anionic and/or nonionic surfactants, nonaqueous organic diluents (for example fatty alcohol alkoxylates or nonpolar organic solvents) and polymers which remove clay soils (for example alkoxylated cationic diamines or polyamines [WO 97/00936] or bleaching agents and salts of divalent metals as bleach activator [WO 97/00937]). Surfactant preparations comparable in consistency containing alkalis, organic builders, etc. in liquid mixtures of anionic and nonionic surfactants and nonaqueous organic thickeners are described in WO 97/02336 (Procter & Gamble). Changes in the viscosity of the preparations in response to shear forces applied to them are not mentioned in any of the cited documents.

WO 98/00507 to WO 98/00512 and WO 98/00514 to WO 98/00517 (Procter & Gamble) describe various nonaqueous (<5% by weight water) liquid laundry detergents in which solid components (bleaching agents, bleaching agent precursors, bleach activators, enzymes) are dispersed or suspended in water-free mixtures containing at least one surfactant and nonaqueous diluents or solvents. The viscosity behavior of such preparations is not discussed in any of the cited documents.

Preparations of the above-mentioned type were normally supplied to the consumer in containers holding relatively large quantities of liquid, such as plastic bottles for example. The preparations were then dosed as required (degree of soiling of the laundry, tableware or substrate, amount of laundry, tableware or substrate) or empirically in each individual case with suitable devices for measuring off quantities of liquid.

Water-free alcohol ether sulfates (isopropanolammonium ether sulfates) as constituents of highly concentrated detergent/cleaner systems are disclosed in the article by U. Schoenkaes et al. entitled “Water-fr e Alcohol Ether Sulfates—New Highly Active Surfactants for Superconcentrated Detergent Formulations”. Such systems are described as showing excellent washing activity and are suitable for the stable incorporation of bleaching agents and other water-sensitive laundry detergent, dishwashing detergent and cleaner components.

It is also stated that the formulations in question can be accommodated in water-soluble gelatin capsules or film bags and can thus be added to the washing, dishwashing or cleaning process as a “pre-dosed” laundry, dishwashing or cleaning portion.

However, besides the disadvantages of possible chemical or physical instability of the constituents making up the particular portion, the detergent/cleaner portions in the form of capsules, balls or film bags described in the cited publication were also attended by the disadvantage of mechanical instability. Capsules, balls or film bags with liquid contents packed in relatively large containers are always in danger of bursting under impact or under the weight of adjacent portions and leaking their liquid contents into the pack. Another disadvantage was that individual portions which were either dropped through carelessness or —when in the form of balls—went out of control by rolling away or which were mechanically damaged—for example by children—leaked their liquid contents into the surrounding environment in the event of even the slightest damage. This was of course unwelcome and the lack of bursting resistance was the reason why many consumers rejected this new form of detergent/cleaner portions.

It has now surprisingly been found that these disadvantages can be remedied by the provision of laundry detergent, dishwashing detergent or cleaner portions based on liquid formulations of washing-, dishwashing- or cleaning-active components, the formulations having a high viscosity. According to the invention, particularly advantageous laundry detergent, dishwashing detergent or cleaner portions are obtained in cases where the liquid formulations have a low viscosity during processing, for example during production from their washing-, dishwashing- or cleaning-active components, during stirring, during pumping and during filling of the envelopes (capsules, balls, bags) intended for the laundry detergent, dishwashing detergent or cleaner portions, but a high viscosity when the mechanical action is no longer applied. A thixotropic or pseudoplastic—in any event non-newtonian—behavior of the liquid formulations of washing-, dishwashing- or cleaning-active components unexpectedly leads to laundry detergent, dishwashing detergent or cleaner portions with distinctly improved functional properties.

Accordingly, the present invention relates to a laundry detergent, dishwashing detergent or cleaner portion comprising a completely or partly water-soluble envelope in the form of a capsule, which completely surrounds a liquid-based formulation of at least one washing-, dishwashing- or cleaning-active material, with a compression resistance of >1 N at 23° C.

In an alternative embodiment, the present invention relates to a laundry detergent, dishwashing detergent or cleaner portion comprising a completely or partly water-soluble envelope in the form of a ball, which completely surrounds a liquid-based formulation of at least one washing-, dishwashing- or cleaning-active material, with a compression resistance of >1 N at 23° C.

In another alternative embodiment, the present invention relates to a laundry detergent, dishwashing detergent or cleaner portion comprising a completely or partly water-soluble envelope in the form of a bag, which completely surrounds a liquid-based formulation of at least one washing-, dishwashing- or cleaning-active material, with a compression resistance of >1 N at 23° C.

The present invention also relates to a process for the production of a laundry detergent, dishwashing detergent or cleaner portion comprising a completely or partly water-soluble envelope in the form of a capsule, ball or bag which in turn completely surrounds a liquid-based formulation of at least one washing-, dishwashing- or cleaning-active material, characterized in that it comprises the steps of

(a) initially introducing at least one liquid component of the liquid-based formulation of at least one washing-, dishwashing- or cleaning-active material and agitating it by application of a certain shear force;

(b) optionally adding one or more other liquid component(s) of the liquid-based formulation;

(c) optionally incorporating one or more solid component(s) of the liquid-based formulation in the liquid phase thus prepared and then optionally adding one or more other solid and/or liquid component(s) while maintaining a certain shear force; and

(d) optionally introducing the liquid mixture prepared in step (c) immediately into the envelope and closing the envelope around the liquid-based formation.

The present invention also relates to a washing process, a dishwashing process and a cleaning process using the laundry detergent, dishwashing detergent and cleaner portions described in detail hereinafter.

A “laundry detergent, dishwashing detergent or cleaner portion (referred to in short as a detergent/cleaner portion)” in the context of the present invention is understood to be a dose of a laundry detergent, dishwashing detergent or cleaner which is sufficient for a washing, dishwashing or cleaning process taking place in an aqueous phase. This may be, for example, a machine washing, dishwashing or cleaning process carried out in commercially available washing, dishwashing or cleaning machines. However, the expression “detergent/cleaner portion” is also understood to encompass handwashing (carried out for example in a handwashing basin or in a bowl) or manual dishwashing or cleaning carried out with a cleaning liquor in a vessel, such as a bucket, or any other washing, dishwashing or cleaning process. According to the invention, the detergent/cleaner portions are preferably used in machine washing, dishwashing or cleaning processes.

A “laundry detergent part-portion” or “dishwashing detergent part-portion” or “cleaner part-portion” (referred to in short as a detergent/cleaner part-portion) in the context of the invention is understood to be part of a detergent/cleaner portion which is present in a phase separated from other detergent/cleaner part-portions in spatial combination with other detergent/cleaner part-portions of the same detergent/cleaner portion and which is prepared by suitable measures in such a way that it can be introduced into the liquor separately from other part-portions of the same detergent/cleaner portion and optionally dissolved or suspended therein. A detergent/cleaner part-portion can contain the same ingredients as another detergent/cleaner part-portion of the same detergent/cleaner portion. However, two detergent/cleaner part-portions of the same detergent/cleaner portion preferably contain different ingredients, more particularly different washing-, dishwashing or cleaning-active preparations.

According to the invention, the detergent/cleaner portions contain measured quantities of at least one washing-, dishwashing- or cleaning-active preparation, normally measured quantities of several washing-, dishwashing- or cleaning-active preparations. The portions may only contain washing-, dishwashing- or cleaning-active preparations having a particular composition. According to the invention, however, several, normally at least two, washing-, dishwashing- or cleaning-active preparations differing in their composition are preferably present in the detergent/cleaner portions. The composition may differ both in regard to the concentration of the individual components of the washing-, dishwashing or cleaning-active preparation (i.e. quantitatively) and/or in regard to the nature of the individual components of the washing-, dishwashing- or cleaning-active preparation (i.e. qualitatively). In one particularly preferred embodiment, the components are adapted in regard to type and concentration to the functions the detergent/cleaner part-portions are intended to perform in the washing, dishwashing or cleaning process.

In the context of the present invention, the term “washing-active preparation” or “dishwashing-active preparation” or “cleaning-active preparation” is understood to apply to preparations, materials or components of any conceivable substances that are relevant to a washing, dishwashing or cleaning process. These are primarily the actual laundry or dishwashing detergents or cleaners themselves with their individual components explained in more detail hereinafter. These include such active ingredients as surfactants (anionic, nonionic, cationic and amphoteric surfactants), builders (inorganic and organic builders), bleaching agents (for example peroxo bleaching and chlorine bleaching agents), bleach activators, bleach stabilizers, bleach catalysts, enzymes, special polymers (for example those with cobuilder properties), redeposition inhibitors, dyes and perfumes, although the term is by no means confined to substances belonging to these groups.

However, constituents of such “washing-active preparations (materials, components)”, dishwashing-active preparations (materials, components) or “cleaning-active preparations (materials, components)” can also include washing, dishwashing and cleaning aids. Examples of these are optical brighteners, UV absorbers, soil repellents, i.e. polymers which counteract resoiling of fibers or hard surfaces, and silver protectors. Laundry treatment compositions, such as fabric softeners, and dishwasher detergent additives, such as rinse agents, are also regarded as washing-active preparations and dishwashing-active preparations, respectively, in the context of the present invention.

The detergent/cleaner portion according to the invention comprises a completely or partly water-soluble envelope. According to the invention, the envelope is not confined to a particular shape. Basically, the shape of the envelope may be based on any Archimedean or Platonian bodies, i.e. three-dimensional shaped bodies. Examples of the shape of the envelope include capsules, cubes, spheres, oval shaped bodies, squares, cones, bars or bags. Blow moldings with one or more compartments which are described in co-pending patent application DE 100 33 827.5 entitled “Compartmented blow molding” are also suitable envelopes for the washing-, dishwashing- or cleaning-active materials. In preferred embodiments of the invention, the envelopes are in the form of capsules (of the type also used, for example, in pharmacology for administering medicaments), balls or bags. Bags are preferably welded or bonded on at least one side, a water-soluble soluble adhesive being used as the adhesive in particularly preferred embodiments of the invention.

Suitable materials for the completely or partly water-soluble envelope are, basically, any materials which are capable of dissolving completely or partly under the given conditions of a washing, dishwashing or cleaning process (temperature, pH value, concentration of washing-active components) in aqueous phase. In a particularly preferred embodiment, the polymer materials may belong to the groups of (partly acetalized) polyvinyl alcohol, polyvinyl pyrrolidone, polyethylene oxide, gelatin, cellulose and cellulose derivatives, starch and starch derivatives, more particularly modified starches, and mixtures (polymer blends, composites, co-extrudates, etc.) of the materials mentioned. Gelatin and polyvinyl alcohols on their own and in combination with starch or modified starch are particularly preferred. Inorganic salts and mixtures thereof are also suitable materials for the at least partly water-soluble envelope.

Polyvinyl alcohols, referred to in short as PVALs, are polymers with the following general structure:

[—CH₂—CH(OH)-]ₙ

which also contain small numbers of structural units of the following type:

[—CH₂—CH(OH)—CH(OH)—CH₂]

Since the corresponding monomer, vinyl alcohol, is not stable in free form, polyvinyl alcohols are produced via polymer-analog reactions by hydrolysis and —on an industrial scale—above all by alkali-catalyzed transesterification of polyvinyl acetates with alcohols (preferably methanol) in solution. PVALs with a predetermined residual percentage of acetate groups can also be obtained by these industrial processes.

Commercially available PVALs (for example Mowiol®) types, products of Hoechst) are marketed as white-yellowish powders or granules with degrees of polymerization of ca. 500 to 2,500 (corresponding to molecular weights of ca. 20,000 to 100,000 g/mol) and have different degrees of hydrolysis starting of, for example, 98-99 or 87-89 mol-%. Accordingly, they are partly saponified polyvinyl acetates with a residual content of acetyl groups of ca. 1-2 or 11-13 mol-%.

The solubility of PVAL in water can be reduced and thus selectively adjusted to required values by aftertreatment with aldehydes (acetalization), by complexing with Ni or Cu salts or by treatment with dichromates, boric acid, borax. Films of PVAL are largely impervious to gases, such as oxygen, nitrogen, helium, hydrogen, carbon dioxide, but are permeable to water vapor.

Examples of suitable water-soluble PVAL films are the PVAL films obtainable under the name of “SOLUBLON®” from Syntana Handelsgesellschaft E. Harke GmbH & Co. Their solubility in water can be very precisely adjusted and films of this product series soluble in water in all the temperature ranges relevant to practical application are obtainable.

Polyvinyl pyrrolidones, referred to in short as PVPs, correspond to the following general formula:

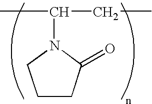

PVPs are produced by radical polymerization of 1-vinyl pyrrolidone. Commercially available PVPs have molecular weights of ca. 2,500 to 750,000 g/mol and are commercially available as white hygroscopic powders or as aqueous solutions.

Polyethylene oxides, referred to in short as PEOXs, are polyalkylene glycols corresponding to the following general formula:

H-[O—CH₂—CH₂]ₙ—OH

which are produced on an industrial scale by base-catalyzed polyaddition of ethylene oxide (oxirane) with ethylene glycol as starter molecule in systems generally containing small quantities of water. They have molecular weights in the range from ca. 200 to 5,000,000 g/mol, corresponding to degrees of polymerization n of ca. 5 to >100,000. Polyethylene oxides have an extremely low concentration of reactive terminal hydroxy groups and possess only weak glycol properties.

Gelatin is a polypeptide (molecular weight ca. 15,000->250,000 g/mol) which is mainly obtained by hydrolysis of the collagen present in the skin and bones of animals under acidic or alkaline conditions. The amino acid composition of gelatin largely corresponds to that of the collagen from which it was obtained and varies according to its provenance. The use of gelatin as a water-soluble capsule material is particularly widespread in pharmacology (hard or soft gelatin capsules). Gelatin is rarely used in the form of films on account of its high price compared with the polymers mentioned above.

Other preferred detergent/cleaner portions according to the present invention are those of which the pack consists of at least partly water-soluble film of at least one polymer from the group of starch and starch derivatives, cellulose and cellulose derivatives, more especially methyl cellulose and mixtures thereof.

Starch is a homoglycan in which the glucose units are attached by α-glycoside bonds. Starch is made up of two components of different molecular weight, namely ca. 20-30% straight-chain amylose (molecular weight ca. 50,000 to 150,000) and 70-80% of branched-chain amylopectin (molecular weight ca. 300,000 to 2,000,000). Small quantities of lipids, phosphoric acid and cations are also present. Whereas the amylose—on account of the bond in the 1,4-position—forms long, helical entwisted chains containing about 300 to 1,200 glucose molecules, the amylopectin chain branches through a 1,6-bond after—on average—25 glucose units to form a branch-like structure containing about 1,500 to 12,000 glucose molecules. Besides pure starch, starch derivatives obtainable from starch by polymer-analog reactions may also be used in accordance with the invention for the production of the water-soluble envelopes of the detergent/cleaner portions. Such chemically modified starches include, for example, products of esterification or etherification reactions in which hydroxy hydrogen atoms were substituted. However, starches in which the hydroxy groups have been replaced by functional groups that are not attached by an oxygen atom may also be used as starch derivatives. The group of starch derivatives includes, for example, alkali metal starches, carboxymethyl starch (CMS), starch esters and ethers and amino starches.

Pure cellulose has the formal empirical composition (C₆H₁₀O₅)ₙ and, in formal terms, is a β-1,4-polyacetal of cellobiose which, in turn, is made up of two molecules of glucose. Suitable celluloses consist of ca. 500 to 5,000 glucose units and, accordingly, have average molecular weights of 50,000 to 500,000. Other cellulose-based disintegrating agents which may be used in accordance with the present invention are cellulose derivatives obtainable from cellulose by polymer-analog reactions. Such chemically modified celluloses include, for example, products of esterification or etherification reactions in which hydroxy hydrogen atoms were substituted. However, celluloses in which the hydroxy groups have been replaced by functional groups that are not attached by an oxygen atom may also be used as cellulose derivatives. The group of cellulose derivatives includes, for example, alkali metal celluloses, carboxymethyl cellulose (CMC), cellulose esters and ethers and also aminocelluloses.

Preferred envelopes of at least partly water-soluble film consist of a polymer with a molecular weight in the range from 5,000 to 500,000 g/mol, preferably in the range from 7,500 to 250,000 g/mol and more preferably in the range from 10,000 to 100,000 g/mol. The water-soluble film which forms the envelope has a thickness of 1 to 300 μm, preferably 2 to 200 μm, more preferably 5 to 150 μm and most preferably 10 to 100 μm.

These water-soluble films may be produced by various processes. In principle, they may be produced by blowing, calendering and casting processes. In one preferred process, which starts out from a melt and uses a blowing mandrel, the films are blown with air to form a tube. In the calendering process, which is another preferred production process, the raw materials plasticized by suitable additives are sprayed to form the films. It may be necessary in the calendering process to dry the films after spraying, In the casting process, which is another preferred production process, an aqueous polymer preparation is applied to a heatable drying roller, optionally cooled after evaporation of the water and the film formed is removed from the roller. This film may optionally be powdered before or during its removal from the roller.

Other suitable materials for the envelope of the detergent/cleaner portion according to the invention are organic and/or inorganic salts. Examples of these salts are salts which can be made into an envelope, for example by crystallization, pressing, compacting or other suitable processes, and which dissolve sufficiently quickly in water or an aqueous liquor under the conditions of the washing, dishwashing or cleaning process. Ideally, salts which are also capable of performing other functions in a washing, dishwashing or cleaning process are used in particularly preferred embodiments of the invention.

In a preferred embodiment of the invention, the envelope as a whole is soluble in water, i.e. dissolves completely when used as intended in washing, dishwashing or cleaning, for example in machine washing, dishwashing or cleaning, when the conditions envisaged for dissolving are established. Particularly preferred completely water-soluble envelopes are, for example, capsules of gelatin, advantageously soft gelatin, or bags of (optionally partly acetalized) PVAL or balls of gelatin or (optionally partly acetalized) PVAL or of one or more organic and/or inorganic salts, preferably balls of soft gelatin. The main advantage of this embodiment is that the envelope dissolves at least partly in the washing/dishwashing/cleaning liquor in a conveniently short time—for example a few seconds to 5 minutes—under precisely defined conditions and thus introduces its contents, i.e. the washing-, dishwashing- or cleaning-active material(s), into the liquor in accordance with requirements.

In another embodiment of the invention, which is also preferred by virtue of advantageous properties, the water-soluble envelope comprises poorly water-soluble or completely water-insoluble regions or regions which only dissolve in water at elevated temperature and readily water-soluble regions or regions which dissolve in water at low temperatures. In other words, the envelope does not consist of a single material with the same solubility in water throughout, but of materials differing in their solubility in water. In this connection, readily water-soluble regions are to be distinguished on the one hand from less readily water-soluble, poorly water-soluble or completely water-insoluble regions or, on the other hand, from regions where solubility in water only reaches the required value at elevated temperature or at a different pH or at a modified electrolyte concentration. The effect of this can be that, when used as intended under adjustable conditions, certain regions of the envelope dissolve while other regions remain intact. This results in an envelope provided with pores or holes into which water and/or liquor can penetrate, dissolve washing-, dishwashing- or cleaning-active ingredients and release them from the envelope. Envelope systems in the form of multicompartment bags or in the form of blow moldings disposed in one another (for example balls: “onion system”) can also be similarly provided. Systems with controlled release of the washing-, dishwashing- or cleaning-active ingredients can be produced in this way.

The invention is not limited in any way in regard to the formation of such systems. Thus, envelopes can be provided in which a single polymer material comprises small regions of incorporated compounds (for example salts) which dissolve in water more quickly than the polymer material. On the other hand, several polymer materials differing in their solubility in water can be mixed (polymer blend) so that, under defined conditions, the polymer material dissolving more quickly is disintegrated by water or by the liquor more quickly than the more slowly dissolving polymer material.

In a particularly preferred embodiment of the invention, the poorly water-soluble or completely water-insoluble regions of the envelope or the regions which only dissolve in water at elevated temperature consist of a material which, chemically, substantially corresponds to that of the readily water-soluble regions or the regions which dissolve in water at relatively low temperatures, but which has a greater layer thickness and/or a modified degree of polymerization of the same polymer and/or a higher degree of crosslinking of the same polymer structure and/or a higher degree of acetalization (in the case of PVAL) and/or a content of water-insoluble salt components and/or a content of a water-insoluble polymer. Even allowing for the fact that the envelope does not dissolve completely, detergent/cleaner portions according to the invention with advantageous properties in terms of the release of the washing-, dishwashing- or cleaning-active components into the particular liquor can be provided in this way.

Another embodiment of the invention, which is also preferred by virtue of its advantageous properties, are detergent/cleaner portions in which the completely or partly water-soluble envelope contains one or more incorporated washing-, dishwashing- or cleaning-active components, more particularly components which are only present in small quantities in laundry detergents, dishwashing detergents or cleaners. Examples of such components are bleaching agents or at least partial amounts thereof, bleach activators, enzymes, dyes, perfumes, optical brighteners and/or sol repellents and other components of the detergent/cleaner portions.

According to the invention, the completely or partly water-soluble envelope of the detergent/cleaner portions according to the invention completely surrounds a liquid-based formulation of at least one washing-, dishwashing- or cleaning-active material. In the context of the invention, “liquid-based” is intended to mean that the formulation of a washing-, dishwashing- or cleaning-active material or several washing-, dishwashing- or cleaning-active materials, at least during its production, is a formulation produced on the basis of liquid components, as explained in detail in the following, even if this formulation contains relatively large quantities of solid components (suspended or dispersed) and/or, after production, undergoes an increase in viscosity in the absence of shear forces, for example of at least 10%, preferably of at least 50% and more preferably of at least 100%, so that it can no longer be described as “liquid” in the narrower sense.

Liquid-based formations of the detergent/cleaner portions according to the invention completely surrounded by the envelopes may be either low-water formulations or substantially water-free formulations. Low-water formulations contain water as an essential component in a quantity of, for example, <15% by weight, based on the weight of all components of the formulation. On the other hand, nonaqueous or substantially water-free formulations only contain water in small quantities, preferably in quantities of <5% by weight and more preferably in quantities of 1 to 3% by weight, based on the weight of all components of the formulation, nonaqueous or substantially water-free formulations being particularly preferred.

With both the low-water and the water-free systems, the formulations contain surfactant(s), anionic, nonionic, cationic and/or amphoteric surfactants being used. Mixtures of anionic and nonionic surfactants are preferred from the performance perspective. Such mixtures should contain more nonionic surfactant than anionic surfactant. The total surfactant content of the detergent/cleaner portions is preferably above 30% by weight, based on the liquid laundry detergent as a whole.

The nonionic surfactants used are preferably alkoxylated, advantageously ethoxylated, more particularly primary alcohols preferably containing 8 to 18 carbon atoms and an average of 1 to 12 mol ethylene oxide (EO) per mol alcohol, in which the alcohol residue may be linear or, preferably, 2-methyl-branched or may contain linear and methyl-branched residues in the form of the mixtures typically present in oxoalcohol residues. However, alcohol ethoxylates containing linear residues of alcohols of native origin with 12 to 18 carbon atoms, for example coconut oil fatty alcohol, palm oil fatty alcohol, tallow fatty alcohol or oleyl alcohol, and an average of 2 to 8 EO per mol alcohol are particularly preferred. Preferred ethoxylated alcohols include, for example, C₁₂₋₁₄ alcohols containing 3 EO, 4 EO or 7EO, C₉₋₁₁ alcohols containing 7 EO, C₁₃₋₁₅ alcohols containing 3 EO, 5 EO, 7 EO or 8 EO, C₁₂₋₁₈ alcohols containing 3 EO, 5 EO or 7 EO and mixtures thereof, such as mixtures of C₁₂₋₁₄ alcohol containing 3 EO and C₁₂₋₁₈ alcohol containing 7 EO. The degrees of ethoxylation mentioned are statistical mean values which, for a special product, may be either a whole number or a broken number. Preferred alcohol ethoxylates have a narrow homolog distribution (narrow range ethoxylates, NRE). In addition to these nonionic surfactants, fatty alcohols containing more than 12 EO may also be used. Examples of such fatty alcohols are tallow fatty alcohols containing 14 EO, 25 EO, 30 EO or 40 EO. Nonionic surfactants containing EO and PO groups together in the molecule may also be used in accordance with the invention. Block copolymers containing EO-PO block units or PO-EO block units and also EO-PO-EO copolymers and PO-EO-PO copolymers may be used. Mixed-alkoxylated nonionic surfactants in which EO and PO units are distributed statistically rather than in blocks may of course also be used. Products such as these can be obtained by the simultaneous action of ethylene and propylene oxide on fatty alcohols.

In addition, alkyl glycosides corresponding to the general formula RO(G)ₓ, where R is a primary linear or methyl-branched, more particularly 2-methyl-branched, aliphatic radical containing 8 to 22 and preferably 12 to 18 carbon atoms and G stands for a glycose unit containing 5 or 6 carbon atoms, preferably for glucose, may be used as further nonionic surfactants. The degree of oligomerization x, which indicates the distribution of monoglycosides and oligoglycosides, is a number of 1 to 10 and preferably a number of 1.2 to 1.4.

Another class of preferred nonionic surfactants which may be used either as sole nonionic surfactant or in combination with other nonionic surfactants are alkoxylated, preferably ethoxylated or ethoxylated and propoxylated, fatty acid alkyl esters preferably containing 1 to 4 carbon atoms in the alkyl chain, more especially the fatty acid methyl esters which are described, for example, in Japanese patent application JP 58/217598 or which are preferably produced by the process described in International patent application WO-A-90/13533.

Nonionic surfactants of the amine oxide type, for example N-cocoalkyl-N,N-dimethylamine oxide and N-tallowalkyl-N,N-dihydroxyethyl-amine oxide, and the fatty acid alkanolamide type are also suitable. The quantity in which these nonionic surfactants are used is preferably no more than the quantity in which the ethoxylated fatty alcohols are used and, more preferably, no more than half that quantity.

Other suitable surfactants are polyhydroxyfatty acid amides corresponding to formula (I):

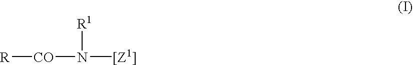

in which RCO is an aliphatic acyl group containing 6 to 22 carbon atoms, R¹ is hydrogen, an alkyl or hydroxyalkyl group containing 1 to 4 carbon atoms and [Z¹] is a linear or branched polyhydroxyalkyl group containing 3 to 10 carbon atoms and 3 to 10 hydroxyl groups. The polyhydroxyfatty acid amides are known substances which may normally be obtained by reductive amination of a reducing sugar with ammonia, an alkylamine or an alkanolamine and subsequent acylation with a fatty acid, a fatty acid alkyl ester or a fatty acid chloride.

The group of polyhydroxyfatty acid amides also includes compounds corresponding to formula (II):

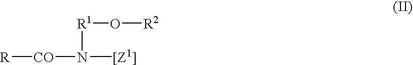

in which R is a linear or branched alkyl or alkenyl group containing 7 to 12 carbon atoms, R¹ is a linear, branched or cyclic alkylene group or an arylene group containing 2 to 8 carbon atoms and R² is a linear, branched or cyclic alkyl group or an aryl group or an oxyalkyl group containing 1 to 8 carbon atoms, C₁₋₄ alkyl or phenyl groups being preferred, and [Z²] is a linear polyhydroxyalkyl group, of which the alkyl chain is substituted by at least two hydroxyl groups, or alkoxylated, preferably ethoxylated or propoxylated, derivatives of that group.

[Z²] is preferably obtained by reductive amination of a sugar, for example glucose, fructose, maltose, lactose, galactose, mannose or xylose. The N-alkoxy- or N-aryloxy-substituted compounds may then be converted into the required polyhydroxyfatty acid amides by reaction with fatty acid methyl esters in the presence of an alkoxide as catalyst, for example in accordance with the teaching of International patent application WO-A-95/07331.

The nonionic surfactant content of preferred formulations is in the range from 5 to 95% by weight, preferably in the range from 10 to 60% by weight and more particularly in the range from 15 to 50% by weight, based on the formulation as a whole.

Suitable anionic surfactants are, for example, those of the sulfonate and sulfate type. Suitable surfactants of the sulfonate type are preferably C₉₋₁₃ alkyl benzenesulfonates, olefin sulfonates, i.e. mixtures of alkene and hydroxyalkane sulfonates, and the disulfonates obtained, for example, from C₁₂₋₁₈ monoolefins with an internal or terminal double bond by sulfonation with gaseous sulfur trioxide and subsequent alkaline or acidic hydrolysis of the sulfonation products. Other suitable surfactants of the sulfonate type are the alkane sulfonates obtained from C₁₂₋₁₈ alkanes, for example by sulfochlorination or sulfoxidation and subsequent hydrolysis or neutralization. The esters of α-sulfofatty acids (ester sulfonates), for example the α-sulfonated methyl esters of hydrogenated coconut oil, palm kernel oil or tallow fatty acids, are also suitable.

Other suitable anionic surfactants are sulfonated fatty acid glycerol esters. Fatty acid glycerol esters in the context of the present invention are the monoesters, diesters and triesters and mixtures thereof which are obtained where production is carried out by esterification of a monoglycerol with 1 to 3 mol fatty acid or in the transesterification of triglycerides with 0.3 to 2 mol glycerol. Preferred sulfonated fatty acid glycerol esters are the sulfonation products of saturated fatty acids containing 6 to 22 carbon atoms, for example caproic acid, caprylic acid, capric acid, myristic acid, lauric acid, palmitic acid, stearic acid or behenic acid.

Preferred alk(en)yl sulfates are the alkali metal salts and, in particular, the sodium salts of the sulfuric acid semiesters of C₁₂₋₁₈ fatty alcohols, for example cocofatty alcohol, tallow fatty alcohol, lauryl, myristyl, cetyl or stearyl alcohol, or C₁₀₋₂₀ oxoalcohols and the corresponding semiesters of secondary alcohols with the same chain length. Other preferred alk(en)yl sulfates are those with the chain length mentioned which contain a synthetic, linear alkyl chain based on a petrochemical and which are similar in their degradation behavior to the corresponding compounds based on oleochemical raw materials. C₁₂₋₁₆ alkyl sulfates, C₁₂₋₁₅ alkyl sulfates and C₁₄₋₁₅ alkyl sulfates are preferred from the point of view of washing technology. Other suitable anionic surfactants are 2,3-alkyl sulfates which may be produced, for example, in accordance with U.S. Pat. No. 3,234,258 or U.S. Pat. No. 5,075,041 and which are commerially obtainable as products of the Shell Oil Company under the name of DAN®.

The sulfuric acid monoesters of linear or branched C₇₋₂₁ alcohols ethoxylated with 1 to 6 moles of ethylene oxide, such as 2-methyl-branched C₉₋₁₁ alcohols containing on average 3.5 moles of ethylene oxide (EO) or C12-18 fatty alcohols containing 1 to 4 EO, are also suitable. In view of their high foaming capacity, they are only used in relatively small quantities, for example in quantities of 1 to 5% by weight, in cleaning compositions.

Other suitable anionic surfactants are the salts of alkyl sulfosuccinic acid which are also known as sulfosuccinates or as sulfosuccinic acid esters and which represent monoesters and/or diesters of sulfosuccinic acid with alcohols, preferably fatty alcohols and, more particularly, ethoxylated fatty alcohols. Preferred sulfosuccinates contain C₈₋₁₈ fatty alcohol residues or mixtures thereof. Particularly preferred sulfosuccinates contain a fatty alcohol residue derived from ethoxylated fatty alcohols which, considered in isolation, represent nonionic surfactants (for a description, see below). Of these sulfosuccinates, those of which the fatty alcohol residues are derived from narrow-range ethoxylated fatty alcohols are particularly preferred. Alk(en)yl succinic acid preferably containing 8 to 18 carbon atoms in the alk(en)yl chain or salts thereof may also be used.

Other suitable anionic surfactants are, in particular, soaps. Suitable soaps are saturated fatty acid soaps, such as the salts of lauric acid, myristic acid, palmitic acid, stearic acid, hydrogenated erucic acid and behenic acid, and soap mixtures derived in particular from natural fatty acids, for example coconut oil, palm kernel oil or tallow fatty acids.

The anionic surfactants, including the soaps, may be present in the form of their sodium, potassium or ammonium salts and as soluble salts of organic bases, such as mono-, di- or triethanolamine for example. The anionic surfactants are preferably present in the form of their ammonium salts, more particularly their ammonium salts with at least one long-chain alkyl group or alkanolamine group at the ammonium nitrogen.

The anionic surfactant content of preferred detergent/cleaner portions is in the range from 5 to 95% by weight, preferably in the range from 10 to 60% by weight and more particularly in the range from 15 to 50% by weight, based on the portion as a whole.

In addition to the one or more surfactant(s), the detergent/cleaner portions according to the invention—whether or not they contain water or are low in water or substantially water-free—may contain other ingredients which further improve the performance and/or aesthetic properties of the formulation. According to the invention, preferred detergent/cleaner portions contain one or more substances from the group of builders, bleaching agents, bleach activators, enzymes, electrolytes, nonaqueous solvents, pH adjusters, perfumes, perfume carriers, fluorescent whitening agents, dyes, hydrotropes, foam inhibitors, silicone oils, redeposition inhibitors, optical brighteners, discoloration inhibitors, shrinkage inhibitors, anti-crease agents, dye transfer inhibitors, antimicrobial agents, germicides, fungicides, antioxidants, corrosion inhibitors, antistatic agents, ironing aids, waterproofing and impregnating agents, swelling and non-slip agents and UV absorbers.

Builders which may be present in the detergent/cleaner portions according to the invention include, in particular, silicates, aluminium silicates (more particularly zeolites), carbonates, salts of organic di- and polycarboxylic acids and mixtures thereof.

Suitable crystalline layer-form sodium silicates correspond to the general formula NaMSiₓO₂ₓ₊₁.y. H₂O, where M is sodium or hydrogen, x is a number of 1.9 to 4 and y is a number of 0 to 20, preferred values for x being 2, 3 or 4. Crystalline layer silicates such as these are described, for example, in European patent application EP-A-0 164 514. Preferred crystalline layer silicates corresponding to the above formula are those in which M is sodium and x assumes the value 2 or 3. Both β- and δ-sodium disilicates Na₂Si₂O₅.yH₂O are particularly preferred, β-sodium disilicate being obtainable, for example, by the process described in International patent application WO-A-91/08171.

Other useful builders are amorphous sodium silicates with a modulus (Na₂O:SiO₂ ratio) of 1:2 to 1:3.3, preferably 1:2 to 1:2.8 and more preferably 1:2 to 1:2.6 which dissolve with delay and exhibit multiple wash cycle properties. The delay in dissolution in relation to conventional amorphous sodium silicates can have been obtained in various ways, for example by surface treatment, compounding, compacting or by overdrying. In the context of the invention, the term “amorphous” is also understood to encompass “X-ray amorphous”. In other words, the silicates do not produce any of the sharp X-ray reflexes typical of crystalline substances in X-ray diffraction experiments, but at best one or more maxima of the scattered X-radiation which have a width of several degrees of the diffraction angle. However, particularly good builder properties may even be achieved where the silicate particles produce crooked or even sharp diffraction maxima in electron diffraction experiments. This may be interpreted to mean that the products have microcrystalline regions between 10 and a few hundred nm in size, values of up to at most 50 nm and, more particularly, up to at most 20 nm being preferred. So-called X-ray amorphous silicates such as these, which also dissolve with delay in relation to conventional waterglasses, are described for example in German patent application DE-A-44 00 024. Compacted amorphous silicates, compounded amorphous silicates and overdried X-ray-amorphous silicates are particularly preferred.

The finely crystalline, synthetic zeolite containing bound water used in accordance with the invention is preferably zeolite A and/or zeolite P. Zeolite MAP® (Crosfield) is a particularly preferred P-type zeolite. However, zeolite X and mixtures of A, X and/or P are also suitable. According to the invention, it is also possible to use, for example, a commercially obtainable co-crystallizate of zeolite X and zeolite A (ca. 80% by weight zeolite X) which is marketed by CONDEA Augusta S.p.A. under the name of VEGOBOND AX®) and which may be described by the following formula:

nNa₂O·(1-n)K₂O·Al₂O₃·(2-2.5)SiO₂·(3.5-5.5) H₂O.

The zeolite may be used as a spray-dried powder or even as an undried suspension still moist from its production. If the zeolite is used in the form of a suspension, the suspension may contain small additions of nonionic surfactants as stabilizers, for example 1 to 3% by weight, based on zeolite, of ethoxylated C₁₂₋₁₈ fatty alcohols containing 2 to 5 ethylene oxide groups, C₁₂₋₁₄ fatty alcohols containing 4 to 5 ethylene oxide groups or ethoxylated isotridecanols. Suitable zeolites have a mean particle size of less than 10 μm (volume distribution, as measured by the Coulter Counter Method) and contain preferably 18 to 22% by weight and more preferably 20 to 22% by weight of bound water.

The generally known phosphates may of course also be used as builders providing their use should not be avoided on ecological grounds. The sodium salts of the orthophosphates, the pyrophosphates and, in particular, the tripolyphosphates are particularly suitable.

Among the compounds yielding H₂O₂ in water which serve as bleaching agents, sodium perborate tetrahydrate and sodium perborate monohydrate are particularly important. Other useful bleaching agents are, for example, sodium percarbonate, peroxypyrophosphates, citrate perhydrates and H₂O₂-yielding peracidic salts or peracids, such as perbenzoates, peroxophthalates, diperazelaic acid, phthaloiminoperacid or diperdodecane dioic acid.

In order to obtain an improved bleaching effect where washing is carried out at temperatures of 60° C. or lower, bleach activators may be incorporated in the laundry detergent portions according to the invention. The bleach activators may be compounds which form aliphatic peroxocarboxylic acids containing preferably 1 to 10 carbon atoms and more preferably 2 to 4 carbon atoms and/or optionally substituted perbenzoic acid under perhydrolysis conditions. Substances bearing O- and/or N-acyl groups with the number of carbon atoms mentioned and/or optionally substituted benzoyl groups are suitable. Preferred bleach activators are polyacylated alkylenediamines, more particularly tetraacetyl ethylenediamine (TAED), acylated triazine derivatives, more particularly 1,5-diacetyl-2,4-dioxohexahydro-1,3,5-triazine (DADHT), acylated glycolurils, more particularly tetraacetyl glycoluril (TAGU), N-acylimides, more particularly N-nonanoyl succinimide (NOSI), acylated phenol sulfonates, more particularly n-nonanoyl or isononanoyloxybenzene-sulfonate (n- or iso-NOBS), carboxylic anhydrides, more particularly phthalic anhydride, acylated polyhydric alcohols, more particularly triacetin, ethylene glycol diacetate and 2,5-diacetoxy-2,5-dihydrofuran, and triethylacetyl citrate (TEAC).

In addition to or instead of the conventional bleach activators mentioned above, so-called bleach catalysts may also be incorporated in the detersive preparations for the detergent/cleaner portions. Bleach catalysts are bleach-boosting transition metal salts or transition metal complexes such as, for example, manganese-, iron-, cobalt-, ruthenium- or molybdenum-salen complexes or carbonyl complexes. Manganese, iron, cobalt, ruthenium, molybdenum, titanium, vanadium and copper complexes with nitrogen-containing tripod ligands and cobalt-, iron-, copper- and ruthenium-ammine complexes may also be used as bleach catalysts.

Suitable enzymes are, in particular, those from the classes of hydrolases, such as proteases, esterases, lipases or lipolytic enzymes, amylases, cellulases or other glycosyl hydrolases and mixtures thereof. All these hydrolases contribute to the removal of stains, such as protein-containing, fat-containing or starch-containing stains, and discoloration in the washing process. In addition, cellulases and other glycosyl hydrolases can contribute towards color retention and towards increasing fabric softness by removing pilling and microfibrils. Oxidoreductases may also be used for bleaching and for inhibiting dye transfer. Enzymes obtained from bacterial strains or fungi, such as Bacillus subtilis, Bacillus licheniformis, Streptomyces griseus, Coprinus cinereus and Humicola insolens are particularly suitable. Proteases of the subtilisin type are preferably used, proteases obtained from Bacillus lentus being particularly preferred. Of particular interest for the detergent/cleaner portions according to the invention are enzyme mixtures, for example of protease and amylase or protease and lipase or lipolytic enzymes or protease and cellulase or of cellulase and lipase or lipolytic enzymes or of protease, amylase and lipase or lipolytic enzymes or protease, lipase or lipolytic enzymes and cellulase, but especially protease- and/or lipase-containing mixtures or mixtures with lipolytic enzymes. Examples of such lipolytic enzymes are the known cutinases. Peroxidases or oxidases have also been successfully used in some cases. Suitable amylases include in particular α-amylases, isoamylases, pullanases and pectinases. Preferred cellulases are cellobio-hydrolases, endoglucanases and β-glucosidases, which are also known as cellobiases, and mixtures thereof. Since the various cellulase types differ in their CMCase and avicelase activities, the desired activities can be established by mixing the cellulases in the appropriate ratios.

The enzymes may be adsorbed to supports and/or encapsulated in membrane materials to protect them against premature decomposition or may even be encapsulated in the water-soluble envelopes according to the invention. The percentage content of enzymes, enzyme mixtures or enzyme granules may be, for example, about 0.1 to 5% by weight and is preferably from 0.12 to about 2% by weight.

Various salts may be used as electrolytes from the group of inorganic salts. Preferred cations are the alkali metals and alkaline earth metals; preferred anions are the halides and sulfates. From the production point of view, it is preferred to use NaCl or MgCl₂ in the formulations according to the invention. The percentage electrolyte content of the formulations according to the invention is normally 0.5 to 5% by weight.

Nonaqueous solvents which may be used in the detergent/cleaner portionss according to the invention belong, for example, to the group of monohydric or polyhydric alcohols, alkanolamines and glycol ethers providing they are miscible with water in the concentration range indicated. The solvents are preferably selected from ethanol, n- or i-propanol, butanols, glycol, propane or butane diol, glycerol, diglycol, propyl or butyl diglycol, hexylene glycol, ethylene glycol methyl ether, ethylene glycol ethyl ether, ethylene glycol propyl ether, ethylene glycol mono-n-butyl ether, diethylene glycol methyl ether, diethylene glycol ethyl ether, propylene glycol methyl, ethyl or propyl ether, dipropylene glycol monomethyl or monoethyl ether, diisopropylene glycol monomethyl or monoethyl ether, methoxy, ethoxy or butoxy triglycol, 1-butoxyethoxy-2-propanol, 3-methyl-3-methoxybutanol, propylene glycol-t-butyl ether. N-butoxypropoxypropanol and mixtures of these solvents. Nonaqueous solvents may be used in the in the detergent/cleaner portions according to the invention in quantities of 0.5 to 90% by weight, preferably below 80% by weight and more preferably below 70% by weight.

In order to bring the pH value of the formulations according to the invention into the required range, it may be advisable to use pH adjusters. Suitable pH regulators are any known acids and alkalis providing their use is not inappropriate for applicational or ecological reasons or on consumer protection grounds. The pH adjusters are normally used in quantities of no more than 2% by weight of the total formulation.

In order to improve their aesthetic impression, the detergent/cleaner portions according to the invention may be colored with suitable dyes. Preferred dyes, which are not difficult for the expert to choose, have high stability in storage, are not affected by the other ingredients of the detergents or by light and do not have any pronounced substantivity for textile fibers so as not to color them.

Foam inhibitors suitable for use in the detergent/cleaner portions according to the invention are, for example, soaps, paraffins and silicone oils optionally applied to carrier materials.

Suitable redeposition inhibitors—also known as soil repellents—are, for example, nonionic cellulose ethers, such as methyl cellulose and methyl hydroxypropyl cellulose containing 15 to 30% by weight of methoxyl groups and 1 to 15% by weight of hydroxypropoxyl groups, based on the nonionic cellulose ether, and the polymers of phthalic acid and/or terephthalic acid known from the prior art or derivatives thereof, more particularly polymers of ethylene terephthalates and/or polyethylene glycol terephthalates or anionically and/or nonionically modified derivatives thereof. Of these, the sulfonated derivatives of phthalic acid and terephthalic acid polymers are particularly preferred.

Optical brighteners (so-called whiteners) may be added to the laundry detergent portions according to the invention to eliminate discoloration and yellowing of the treated laundry. These substances are absorbed onto the fibers and produce a brightening and fake bleaching effect by converting invisible ultraviolet radiation into visible longer-wave light, the ultraviolet radiation absorbed from the sunlight being reflected as a pale bluish fluorescence and giving pure white with the yellow of the discolored or yellowed laundry. Suitable compounds belong, for example, to the classes of 4,4′-diamino-2,2′-stilbene disulfonic acids (flavonic acids), 4,4′-distyryl biphenyls, methyl umbelliferones, coumarins, dihydro-quinolines, 1,3-diaryl pyrazolines, naphthalic acid imides, benzoxazole, benzisoxazole and benzimidazole systems and the heterocycle-substituted pyrene derivatives. The optical brighteners are normally used in quantities of 0.05 to 0.3% by weight, based on the final detergent.

The function of discoloration inhibitors is to keep the soil detached from the fibers suspended in the wash liquor and thus to prevent the soil from being re-absorbed by the washing. Suitable discoloration inhibitors are water-soluble, generally organic colloids, for example glue, gelatin, salts of ether sulfonic acids of starch or cellulose or salts of acidic sulfuric acid esters of cellulose or starch. Water-soluble polyamides containing acidic groups are also suitable for this purpose. Soluble starch preparations and other starch products than those mentioned above, for example degraded starch, aldehyde starches, etc., may also be used. Polyvinyl pyrrolidone is also suitable. However, cellulose ethers, such as carboxymethyl cellulose (sodium salt), methyl cellulose, hydroxyalkyl cellulose, and mixed ethers, such as methyl hydroxyethyl cellulose, methyl hydroxypropyl cellulose, methyl carboxymethyl cellulose and mixtures thereof, in quantities of 0.1 to 5% by weight, based on the detergent, are preferably used. Discoloration inhibitors based on optionally modified polyacrylates and copolymers thereof may also be used for the purposes of the invention Since flat textiles, particularly of Reyon®, rayon staple, cotton and blends thereof, can show a tendency to crease because the individual fibers are sensitive to sagging, folding, pressing and squeezing transversely of the fiber direction, the laundry detergents according to the invention may contain synthetic anti-crease agents. These include, for example, synthetic products based on fatty acids, fatty acid esters, fatty acid amides, alkylol esters, alkylol amides or fatty alcohols mostly reacted with ethylene oxide or products based on lecithin or modified phosphoric acid esters.

For protection against microorganisms, the detergent/cleaner portions according to the invention may contain antimicrobial agents. Depending on the antimicrobial spectrum and the action mechanism, antimicrobial agents are classified as bacteriostatic agents and bactericides, fungistatic agents and fungicides, etc. Important representatives of these groups are, for example, benzalkanolium chlorides, alkylaryl sulfonates, halophenols and phenol mercuriacetate. However, the detergents according to the invention may also be completely free from these compounds.

In order to prevent unwanted changes to the detergent/cleaner portions and/or the treated fabrics caused by the effect of oxygen and other oxidative processes, the formulations may contain antioxidants. This class of compounds includes, for example, substituted phenols, hydroquinones, pyrocatechols and aromatic amines and also organic sulfides, polysulfides, dithiocarbamates, phosphites and phosphonates.

Increased wearing comfort can be obtained from the additional use of antistatic agents which may be additionally incorporated in the laundry detergent portions according to the invention. Antistatic agents increase surface conductivity and thus provide for the improved dissipation of any charges developed. External antistatic agents are generally substances containing at least one hydrophilic molecule ligand and form a more or less hygroscopic film on the surface. These generally interfacially active anti-static agents may be divided into nitrogen-containing antistatics (amines, amides, quaternary ammonium compounds), phosphorus-containing antistatics (phosphoric acid esters) and sulfur-containing antistatics (alkyl sulfonates, alkyl sulfates). External antistatics are described, for example, in patent applications FR 1 156 513, GB 873,214 and GB 839,407. The lauryl (or stearyl) dimethyl benzylammonium chlorides disclosed therein are suitable as antistatics for textiles or as a detergent additive, a conditioning effect additionally being obtained.

In order to improve the water absorption capacity and the rewettability of the treated textiles and to make them easier to iron, silicone derivatives, for example, may be used in the laundry detergent portions according to the invention. These silicone derivatives additionally improve the rinse-out behavior of the portions according to the invention by virtue of their foam-inhibiting properties. Preferred silicone derivatives are, for example, polydialkyl and alkylaryl siloxanes where the alkyl groups contain 1 to 5 carbon atoms and are completely or partly fluorinated. Preferred silicones are polydimethyl siloxanes which may optionally be derivatized and are then aminofunctional or quaternized or bear Si—OH, Si—H and/or Si—Cl bonds. The preferred silicones have viscosities at 25° C. of 100 to 100,000 mPas and may be used in quantities of 0.2 to 5% by weight, based on the detergent as a whole.

Finally, the formulations according to the invention may also contain UV filters which are adsorbed onto the treated textiles and which improve the fastness of the fibers to light. Compounds which show these desirable properties are, for example, the compounds and derivatives of benzophenone with substituents in the 2- and/or 4-position which act through radiationless deactivation. Also suitable are substituted benzotriazoles, 3-phenyl-substituted acrylates (cinnamic acid derivatives), optionally with cyano groups in the 2-position, salicylates, organic Ni complexes and natural substances, such as umbelliferone and the body's own urocanic acid.

In order to avoid the decomposition of certain detergent ingredients catalyzed by heavy metals, heavy metal complexing agents may be used. Suitable heavy metal complexing agents are, for example, the alkali metal salts of ethylenediamine tetraacetic acid (EDTA) or nitrilotriacetic acid (NTA) or derivatives thereof and alkali metal salts of anionic polyelectrolytes, such as polymaleates and polysulfonates.

A preferred class of complexing agents are the phosphonates which are present in preferred detergent/cleaner portions in quantities of 0.01 to 1.5% by weight, preferably 0.02 to 1% by weight and more preferably 0.03 to 0.5% by weight. These preferred compounds include in particular organophosphonates such as, for example, 1-hydroxyethane-1,1-diphosphonic acid (HEDP), aminotri(methylene phosphonic acid) (ATMP), diethylenetriamine penta(methylene phosphonic acid) (DTPMP or DETPMP) and 2-phosphonobutane-1,2,4-tricarboxylic acid (PBS-AM), which are mostly used in the form of their ammonium or alkali metal salts.

In other preferred embodiments of the detergent/cleaner portions according to the invention, the low-water formulations includes a thickening system which may consist of one or more component(s). Normally, one component is a polymeric thickener. These organic high molecular weight compounds, which are also known as swelling agents and which take up liquids and swell in the process and, finally, change into viscous, true or colloidal solutions, belong to the groups of natural polymers, modified natural polymers and fully synthetic polymers.

Naturally occurring polymers which may be used as thickeners in accordance with the invention are, for example, agar agar, carrageen, tragacanth, gum arabic, alginates, pectins, polyoses, guar gum, locust bean gum, starch, dextrins, gelatin and casein.

Modified natural materials belong above all to the group of modified starches and celluloses, of which carboxymethyl cellulose and cellulose ethers, hydroxyethyl cellulose and hydroxypropyl cellulose and also gum ethers are mentioned as examples.

A large group of thickeners which are widely used in various fields of application are the fully synthetic polymers, such as polyacrylic and poly-methacrylic compounds, vinyl polymers, polycarboxylic acids, polyethers, polyimines, polyamides and polyurethanes.

Thickeners from the classes of compounds mentioned are commercially obtainable and are marketed, for example, under the names of Acusol® 820 (methacrylic acid (stearyl alcohol-20 EO) ester/acrylic acid copolymer, 30% in water; Rohm & Haas), Dapral® GT 282 S (alkyl polyglycol ether; Akzo), Deuterol®) Polymer-11 (dicarboxylic acid copolymer; Schöner GmbH), Deuteron® XG (anionic heteropolysaccharide based on β-D-glucose, D-mannose, D-glucuronic acid; Schöner GmbH), Deuteron® XN (nonionic polysaccharide; Schöner GmbH), Dicrylan®) Verdicker-O (ethylene oxide adduct, 50% in water/isopropanol; Pfersse Chemie), EMA® 81 and EMA® 91 (ethylene/maleic anhydride copolymer; Monsanto), Verdicker-QR-1001 (polyurethane emulsion, 19-21% in water/diglycol ether; Rohm & Haas), Mirox®-AM (anionic acrylic acid/acrylate copolymer dispersion, 25% in water; Stockhausen), SER-AD-FX-1100 (hydrophobic urethane polymer; Servo Delden), Shellflo® S (high molecular weight polysaccharide, stabilized with formaldehyde; Shell) and Shellflo® XA (xanthan biopolymer, stabilized with formaldehyde; Shell).

Preferred low-water formulations contain 0.01 to 4% by weight, preferably 0.1 to 3% by weight and more preferably 0.4 to 1.5% by weight of a polysaccharide as one component of the thickening system.

A polymeric thickener preferably used is xanthan, a microbial anionic heteropolysaccharide which is produced by Xanthomonas campestris and a few other species under aerobic conditions and which has a molecular weight of 2 to 15 million g/mol. Xanthan consists of a chain with β-1,4-glucose (cellulose) with side chains. The structure of the sub-groups consists of glucose, mannose, glucuronic acid, acetate and pyruvate, the number of pyruvate units determining the viscosity of the xanthan.

Xanthans and modified xanthans may be used with particular advantage by virtue of their high stability to acids and oxidation.

Xanthan may be described by the following formula:

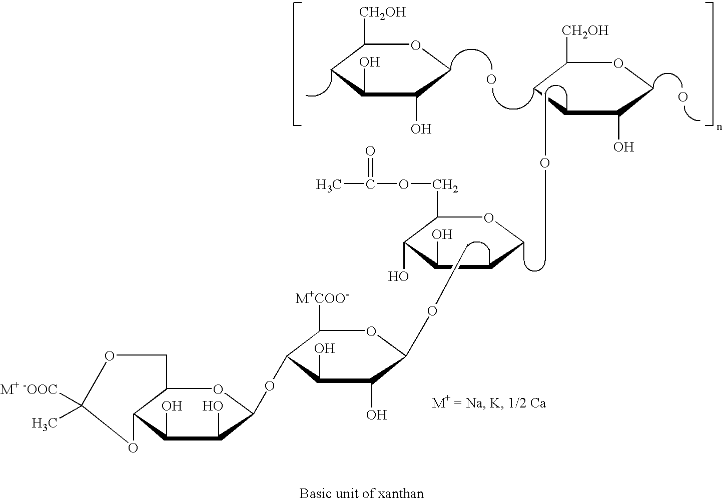

Preferred water-based formulations of the detergent/cleaner portions contain—based on the detergent as a whole—0.01 to 4% by weight, preferably 0.1 to 3% by weight and more particularly 0.4 to 1.5% by weight of xanthan as component a) of the thickening system.

Other components of the thickening system are described in the prior art literature, for example in WO 99/27051 where the second component of the thickening system is a boron compound which is used in quantities of 0.5 to 7% by weight. Examples of boron compounds which may be used in accordance with the invention are boric acid, boron oxide, alkali metal borates, such as ammonium, sodium and potassium ortho-, meta- and pyro-borates, borax in its various stages of hydration and polyborates, such as alkali metal pentaborates for example. Organoboron compounds, such as esters of boric acid, may also be used. Preferred liquid detergent portions contain 0.0001 to 5% by weight, preferably 0.001 to 4% by weight and more particularly 0.01 to 3% by weight of a boron compound.

The detergent/cleaner portions according to the invention may contain 0 to 20% by weight of a complexing agent as a third component of the thickening system. Complexing agents in the context of the invention are understood to be low molecular weight hydroxycarboxylic acids, such as citric acid, tartaric acid, malic acid or gluconic acid or salts thereof.

Particularly preferred liquid detergent portions contain citric acid or sodium citrate as component c) of the thickening system, preferred liquid detergent portions being characterized in that they contain 1.0 to 15.0% by weight, preferably 2.0 to 10.0% by weight and more particularly 2.0 to 7.0% by weight sodium citrate.

Another thickening system is described in WO 99/28430 and consists of (based on the formulation of the detergent/cleaner portion)

a) 0.2 to 5% by weight of a polyurethane or a modified polyacrylate,

b) 0.5 to 7% by weight of a boron compound and

c) 1 to 8% by weight of a complexing agent, components (b) and (c) corresponding qualitatively and, optionally, quantitatively to the components of the thickening system described above.

The first component of the thickening system is a polyurethane or a modified polyacrylate which is used in quantities of 0.2 to 5% by weight, based on the portion as a whole.

Polyurethanes are produced by polyaddition from dihydric and higher alcohols and isocyanates and may be described by general formula (III):

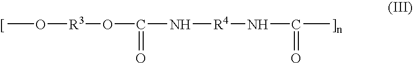

in which R³ is a low molecular weight or polymeric diol residue, R⁴ is an aliphatic or aromatic group and n is a natural number. R³ is preferably a linear or branched C₂₋₁₂ alk(en)yl group, although it may also be a residue of a higher alcohol, so that crosslinked polyurethanes are formed which differ from general formula (III) above in the fact that other —O—CO—NH groups are attached to the substituent R³.

Technically important PURs are produced from polyester and/or polyether diols and, for example, from 2,4- or 2,6-toluene diisocyanate (TDI, R⁴═C₆H₃—CH₃), 4,4′-methylene di(phenyl isocyanate) (MDI, R⁴═C₆H₄—CH₂—C₆H₄) or hexamethylene diisocyanate [HMD¹, R⁴═(CH₂)₆].

Commercially available polyurethane-based thickeners are marketed, for example, under the names of Acrysol®PM 12 V (mixture of 3-5% modified starch and 14-16% PUR resin in water; Rohm & Haas), Borchigel® L75-N (nonionic PUR dispersion, 50% in water; Borchers), Coatex® BR-100-P (PUR dispersion, 50% in water/butyl glycol; Dimed), Nopco® DSX-1514 (PUR dispersion, 40% in water/butyl triglycol; Henkel-Nopco), Verdicker QR 1001 (20% PUR emulsion in water/diglycol ether; Rohm & Haas) and Rilanit® VPW-3116 (PUR dispersion, 43% in water; Henkel).

Preferred detergent/cleaner portions contain 0.01 to 4% by weight, preferably 0.1 to 3% by weight and more particularly 0.5 to 1.5% by weight of a polyurethane.

Optionally modified polyacrylates which may be used in accordance with the present invention are derived, for example, from acrylic acid or methacrylic acid and may be described by general formula (IV):

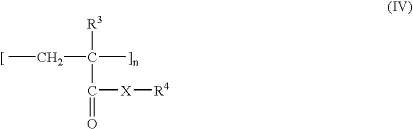

in which R⁵ represents H or a branched or unbranched C₁₋₄ alk(en)yl group, X represents N—R⁷ or O, R⁶ is an optionally alkoxylated, branched or unbranched, optionally substituted C₈₋₂₂ alk(en)yl group, R⁷ represents H or has the same meaning as R⁶ and n is a natural number. Modified polyacrylates such as these are generally esters or amides of acrylic acid or of an α-substituted acrylic acid. Of these polymers, those in which R³ represents H or a methyl group are preferred. Among the polyacrylamides (X═N—R⁵), both mono- (R⁵═H) and di- (R⁵═R⁴)—N-substituted amide structures are possible, the two hydrocarbon radicals attached to the nitrogen atom being selected independently of one another from optionally alkoxylated branched or unbranched C₈₋₂₂ alk(en)yl radicals. Among the polyacrylates (X=0), those in which the alcohol was obtained from natural or synthetic fats or oils and is additionally alkoxylated, preferably ethoxylated, are preferred. Preferred degrees of alkoxylation are from 2 to 30, degrees of alkoxylation of 10 to 15 being particularly preferred.

Since the polymers suitable for use in accordance with the invention are technical compounds, the designation of the groups attached to X represents a statistical mean value which, in the individual case, can vary in regard to chain length or degree of alkoxylation. Formula (IV) merely indicates formulae for idealized homopolymers. However, copolymers in which the percentage content of monomer units corresponding to formula (IV) is at least 30% by weight may also be used in accordance with the present invention. For example, copolymers of modified polyacrylates and acrylic acid or salts thereof which also contain acidic H atoms or basic —COO) groups may also be used.

According to the invention, preferred modified polyacrylates are polyacrylate/polymethacrylate copolymers which correspond to formula (IVa):

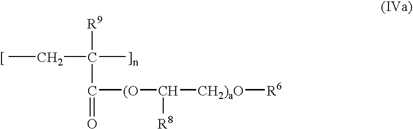

in which R⁶ is a preferably unbranched, saturated or unsaturated C₈₋₂₂ alk(en)yl group, R⁸ and R⁹ independently of one another represent H or CH₃, the degree of polymerization n is a natural number and the degree of alkoxylation a is a natural number of 2 to 30 and preferably 10 to 20. R⁶ is preferably a fatty alcohol moiety obtained from natural or synthetic sources, the fatty alcohol in turn preferably being ethoxylated (R⁸═H).

Products corresponding to formula (IVa) are commercially obtainable, for example, under the name of Acusol® 820 (Rohm & Haas) in the form of 30% by weight dispersions in water. In the commercial product mentioned, R⁶ is a stearyl group, R⁸ is a hydrogen atom, R⁹ is H or CH₃ and the degree of ethoxylation a is 20.

Preferred detergent/cleaner portions contain 0.01 to 4% by weight, preferably 0.1 to 3% by weight and more particularly 0.5 to 2.0% by weight, based on the fomulation as whole, of a modified polyacrylate corresponding to formula (IV).

Other thickening systems are possible and may be used on their own or in the form of mixtures with other systems for the purposes of the invention.

In cases where the formulation of the washing-, dishwashing- or cleaning-active materials is a low-water or water-free formulation, this low-water ot water-free formulation formulation preferably contains a material comprising one or more anionic surfactant(s) and/or one or more nonionic surfactant(s) for adjusting its rheological parameters. In a particularly preferred embodiment, the anionic surfactant(s) is/are selected from the group of sulfonates and sulfates and mixtures thereof and/or the nonionic surfactant(s) is/are selected from the group of alkoxylated alcohols, alkoxylated fatty acid alkyl esters, alkyl glycosides and mixtures thereof. The groups of compounds mentioned were described in detail in the foregoing.

In low-water or substantially water-free formulations of washing-, dishwashing or cleaning-active materials which are present in the detergent/cleaner portions according to the invention, the isopropanolammonium ether sulfates according to the above-cited article by U. Schoenkaes et al. entitled “Water-free Alcohol Ether Sulfates—New Highly Active Surfactants for Superconcentrated Detergent Formulations” may preferably be used as anionic surfactants, optionally in the presence of other anionic and/or nonionic surfactants. Of these isopropanolammonium ether sulfates, monoisopropanolammonium ether sulfate (MIPA ether sulfate) and triisopropanolammonium ether sulfate (TIPA ether sulfate) are particularly preferred by virtue of their excellent anionic surfactant properties.

Polymers with a thickening effect are also used with advantage in low-water or substantially water-free systems. Such polymers may also be used as associative thickeners. These polymers may be, for example, but do not have to be, acrylate-based polymers, some of which may have relatively high molecular weights of >1,000,000 g/mol. They are used in quantities of 0.01 to 10% by weight, for example in quantities of 0.5 to 4% by weight, in the washing-, dishwashing- or cleaning-active formulations. Suitable products are, for example, the products marketed by Rohm & Haas under the name of Acusol®, which are predominantly polyacrylates with different degrees of alkylation or crosslinking or hydrophobicized nonionic polyols, or the products marketed by B. F. Goodrich under the name of Carbopol®, which are polyacrylates or copolymers of acrylic acid and alkylated (preferably C₅-C₁₀-alkylated) acrylic acids, or the products marketed by B. F. Goodrich under the name of Pemulen®, which are high molecular weight acrylic acid copolymers of the acrylate/C₁₀-C₃₀ alkyl acrylate crosspolymer type. Besides the above-mentioned associative thickeners, polyacrylate or polyurethane thickeners, which enable the viscosity to be adjusted by another mechanism (i.e. non-associative) in the presence of small quantities of water, may also be used in water-free or substantially water-free systems.

According to the invention, detergent/cleaner portions in which the liquid-based formulations show non-newtonian flow behavior, preferably thixotropic or pseudoplastic flow behavior, are also preferred. In particularly preferred embodiments of the portions, the liquid-based formulations have a low viscosity, for example a viscosity of 10 to 50 mPa·s, during production and a higher viscosity, for example of 10 to 100,000 mPa·s, preferably in the range from 100 to 20,000 mPa·s and more particularly in the range from 200 to 10,000 mPa·s, during storage, etc. In the case of clear systems, viscosity can be lower than in systems where solid components (whose presence is reflected in clouding) are present. The latter systems regularly thicken to a greater extent (“set”) in storage and can even assume a paste-like consistency.

Detergent/cleaner portions according to the invention present, for example in the form of capsules, balls or bags show high mechanical stability (according to their particular shape), with the result that they burst far more rarely. Mechanical stability can be measured as compression resistance by methods known per se (described in more detail in the Examples). Compression resistance is generally defined as the resistance which the shaped body offers to the pressure of a punch applied to it (under standardized conditions) and, as mentioned above, depends on the shape of the portion and also on the strength of its ingredients, on the temperature and optionally on other parameters. Detergent/cleaner portions according to the invention present in the form of capsules have a compression resistance of >1 N at 23° C., preferably in the range from 1 to 10⁶ N at 23° C., more preferably in the range from 10 to 10⁵ N at 23° C. and most preferably in the range from 10² to 10⁴ N at 23° C. Detergent/cleaner portions according to the invention present in the form of balls have a compression resistance of >1 N at 23° C., preferably in the range from 1 to 10⁶ N at 23° C., more preferably in the range from 10 to 10⁵ N at 23° C. and most preferably in the range from 10² to 10⁴ N at 23° C. Detergent/cleaner portions according to the invention present in the form of bags have a compression resistance of >1 N at 23° C., preferably in the range from 1 to 10⁶ N at 23° C., more preferably in the range from 10 to 10⁵ N at 23° C. and most preferably in the range from 10² to 10⁴ N at 23° C.

The liquid-based formulations of at least one washing-, dishwashing- or cleaning-active material accommodated in the envelopes of the detergent/cleaner portions may be clear solutions of one or more washing-, dishwashing- or cleaning-active component(s) or microemulsions. According to the invention, however, the liquid-based formulations may contain one or more suspended or dispersed solids, particularly when low-water or substantially water-free formulations are used. This is an advantage over the prior art because water-sensitive components of washing-, dishwashing- or cleaning active materials can be kept stable and uniformly distributed in the liquid phase and problems to do with activity reductions do not arise.

Basically, the process for the production of the detergent/cleaner portions is not subject to any limitations. It is normally carried out simply by mixing the constituents in stirred tank reactors, any water, nonaqueous solvents and liquid surfactant(s) present preferably being introduced first and the other constituents being added in portions. There is no need for separate heating during production. If it is required, the temperature of the mixture should not exceed 80° C.

In a preferred embodiment of the invention, the process for the production of a laundry detergent, dishwashing detergent or cleaner portion comprising a completely or partly water-soluble envelope in the form of a capsule, ball or bag which in turn completely surrounds a liquid-based formulation of at least one washing-, dishwashing- or cleaning-active material comprises the steps of

(a) initially introducing at least one liquid component of the liquid-based formulation of at least one washing-, dishwashing- or cleaning-active material and agitating it by application of a certain shear force;

(b) optionally adding one or more other liquid component(s) of the liquid-based formulation;

(c) optionally incorporating one or more solid component(s) of the liquid-based formulation in the liquid phase thus prepared and then optionally adding one or more other solid and/or liquid component(s) while maintaining a certain shear force; and

(d) optionally introducing the liquid mixture prepared in step (c) immediately into the envelope and closing the envelope around the liquid-based formation.

Alternatively, the liquid mixture prepared in step (c) is introduced belatedly into the envelope which is then closed around the liquid-based formulation.

In a particularly advantageously embodiment, the certain shear force which is applied to the liquid-based formulation of at least one washing-, dishwashing- or cleaning-active material to incorporate the remaining (more particularly solid) components in this formulation and which is expressed hear as the shear rate may be>0.01 min⁻¹ and is preferably in the range from 0.1 to 50,000 min⁻¹, more preferably in the range from 5 to 20,000 min⁻¹ and most preferably in the range from 30 to 10,000 min⁻¹.

The present invention also relates to a laundry washing process, more particularly a process for washing laundry in a commercially available washing machine, comprising the steps of

(a) introducing a laundry detergent portion according to the above detailed description into the washing machine, more particularly into the dispensing compartment or into the washing drum;

(b) establishing contact between the laundry detergent portion and the wash liquor through the addition of water;

(c) establishing the required washing conditions and

(d) with the required conditions in place, releasing the washing-active material(s) of the laundry detergent portion into the wash liquor and bringing it/them into contact with the laundry to be washed.

The present invention also relates to a dishwashing process, more particularly a process for machine dishwashing in a commercially available dishwashing machine, comprising the steps of

(a) introducing a dishwashing detergent portion according to the above detailed description into the dishwashing machine, more particularly into the dispensing compartment or into the tank;

(b) establishing contact between the dishwashing detergent portion and the wash liquor through the addition of water;

(c) establishing the required dishwashing conditions and

(d) with the required conditions in place, releasing the dishwashing-active material(s) of the dishwashing detergent portion into the wash liquor and bringing it/them into contact with the tableware to be cleaned.

The present invention also relates to a cleaning process, characterized comprising the steps of

(a) introducing a cleaner portion according to the above detailed description into the cleaning liquor,

(b) establishing the required cleaning cleaning conditions and

(c) with these conditions in place, releasing the cleaning-active material(s) of the cleaner portion into the cleaning liquor and bringing it/them into contact with the item(s) to be cleaned.

In addition to the applications mentioned above, the portions according to the invention may also be used for other applications. For example, they may also be used as cleaners for lavatory cisterns for releasing a cleaner and disinfectant, optionally continuously, into the flushing water or as cleaners for pipes, etc. For special applications, such cleaners may also contain gas-releasing systems (for example an acid, such as citric acid, with a carbonate, such as sodium carbonate for example).

The following Examples are intended to illustrate the invention without limiting it in any way.

The strength of detergent/cleaner portions according to the invention was determined by the following standardized method:

The determination was carried out with a Zwick 1425 universal testing machine.

At least 10 samples of each sort were tested. In general, the samples were tested immediately after conditioning. However, preliminary storage under various climatic conditions can be carried out on request.

Before testing or preliminary storage, all bags were examined for damage. In addition, the gross weight of the samples was determined.

The samples were conditioned for at least 24 hours before each test. The test was carried out in a standard conditioning atmosphere of 23° C./50% relative humidity.

The test specimens were thoroughly tested in a plastic bag as spray protection. The thickness of the constituent material of this bag should be at least 100 μm. For testing, the film bag was placed centrally on the lower base plate in the spray protection bag. The lower base plate was located vertically below the upper base plate.

The compression press was adjusted to a compression rate of 10 mm/min. Testing was then started. The force [N] applied to the bag at the moment of bursting was printed out on the connected printer.

The bursting strength is expressed in N. The tensile stress is expressed in N/cm².

Besides the compressive strength, the filled area of the bag is also required for this purpose. This is calculated from the height and width of the whole bag minus the welding or sealing seams. The two internal dimensions were measured to an accuracy of 0.1 cm and the area was calculated.

### Examples 1 to 7

The formulations listed in Table 1 below were prepared by stirring together the liquid components introduced first and the optionally finely ground solid components subsequently added. Washing- or dishwashing-active formulations according to the invention were thus produced. The viscosities were measured by the Brookfield method.

Conventional gelatin washing balls (mnufacturer: SwissCaps) were filled with the formulations prepared in accordance with Table 1.

TABLE 1
Formulation Examples for water-free liquid laundry detergents
as a filling for washing balls

| | Formulation No. | | | | | | |
|---|---|---|---|---|---|---|---|
| | 1 | 2 | 3 | 4 | 5 | 6 | 7 |
| ABS powder | − | 20 | 15.5 | 17.5 | 20 | 25 | − |
| Sulfopon 1218 G | − | − | − | − | − | − | 1.5 |
| Lutensol AO 7 | − | − | − | − | 10 | − | − |
| Lutensol AO 5 | − | − | − | − | 15 | − | − |
| Lutensol AO 3 | − | − | − | − | 10 | − | − |
| Dehydol LT 7 | − | 35 | 27.6 | 5.2 | − | − | − |
| Dehydol LS 5 | 38 | − | − | − | − | 28 | − |
| Dehypon LS 54 | 17.73 | 21.85 | − | − | 19 | − | − |
| Dehypon LS 52 R | − | − | − | − | − | − | 61.6 |
| Genapol UD-079 | − | − | − | 25 | − | − | |
| Tixogel MP 250 | − | − | − | − | − | − | 0.6 |
| Propylene carbonate | 1.14 | 0.92 | − | − | 0.8 | − | 1.8 |
| Thixatrol Plus | 0.29 | 0.23 | − | − | 0.2 | − | |
| Perborate monohydrate | 15 | − | 19.3 | 18.2 | − | − | 14 |
| TAED granules | 5 | − | − | − | − | − | 5.5 |
| Triacetin | − | − | − | − | − | 24 | − |
| Triethyl acetyl citrate | − | − | 22.1 | 21.5 | − | − | − |
| Trisodium citrate, water- | 15 | 10 | − | − | − | − | 10 |
| free | | | | | | | |
| Na SKS 6 | − | − | 6.9 | − | − | 10.3 | − |
| Soda | − | − | − | − | 13.2 | − | − |
| Sokalan CP 5 | 3.2 | 5.2 | 5.5 | 5.8 | 5 | 5.5 | − |
| Turpinal 2 NZ | 1 | 1.2 | 1.1 | 1.2 | 1.2 | 1 | 1 |
| Velvetol 251C | − | − | − | − | − | − | 0.2 |
| Tinosorb FD | − | − | 0.1 | − | − | − | − |
| Tinopal CBS-X | 0.1 | 0.1 | − | 0.1 | 0.1 | 0.1 | 0.1 |
| VP 1132 | 0.5 | 0.5 | 0.3 | 0.5 | 0.5 | 0.5 | 0.5 |
| Perfume | + | + | + | + | + | + | + |
| Protease | + | + | − | + | + | + | + |
| Amylase | + | + | − | + | + | + | + |
| Dye | + | + | − | + | + | + | + |
| Residual salts | to 100 | to 100 | to 100 | to 100 | to 100 | to 100 | to 100 |
| Viscosities in mPa · s | | | | | | | |
| After production | | | | | | | |
| 1 r.p.m. | − | 24600 | 14400 | 20400 | 7300 | 18800 | − |
| 5 r.p.m. | 6600 | 8840 | 7240 | 7800 | 3260 | 9840 | 8660 |
| 20 r.p.m. | 2520 | 4470 | 4350 | 4030 | 2020 | 1340 | 2900 |
| After storage for 1 wk./RT | | | | | | | |
| 1 r.p.m. | − | 23200 | 13200 | 21800 | − | 35600 | − |
| Compression resistance | 99.1 | 129.7 | 118.6 | 109.5 | 85.4 | 96.8 | 95.2 |
| at 23° C. (in N) | | | | | | | |

Explanations of the trade names used in Examples 1 and 2:

ABS powder: alkyl benzenesulfonate, 90% (Unger)

Sulfopon 1218 G: C₁₂₋₁₈ fatty alcohol sulfate granules (Cognis)

Lutensol AO7: C₁₃₋₁₅ oxoalcohol ethoxylate+7 mol EO

Lutensol AO 5: C₁₃₋₁₅ oxoalcohol ethoxylate+5 mol EO

Lutensol AO 3: C₁₃₋₁₅ oxoalcohol ethoxylate+3 mol EO

Dehydol LT 7: C₁₂₋₁₈ fatty alcohol ethoxylate+7 mol EO (Cognis)

Dehydol LS 5: C₁₂₋₁₄ fatty alcohol ethoxylate+5 mol EO (Cognis)

Dehypon LS54: C₁₂₋₁₄ fatty alcohol ethoxylate/propoxylate+5 mol EO and 4 mol PO (Cognis)

Dehypon LS 52 R: C₁₂₋₁₄ fatty alcohol ethoxylate/propoxylate random+5 mol EO and 4 mol PO (Cognis)

Genapol UD-79: C₁₁ oxoalcohol ethoxylate+7 mol EO (Clariant)

Tixogel MP 250: organically modified layered silicate (Südchemie)

Thixatrol Plus: diamine wax mixture (Rheox)

TAED: tetraacetyl diamine (Warwick)

Triacetin: glycerol triacetate (Cognis)

Na SKS 6: (Clariant)

Sokalan CP 5: polycarboxylate (BASF)

Turpinal 2NZ: hydroxyethanediphosphonic acid disodium salt (Cognis)

Velvetol 251 C: terephthalic acid/ethylene glycol/PEG polyester (Rhodia)

Tinopal CBS-X: optical brightener (CIBA)

Tinosorb FD: UV absorber (CIBA)

VP 1132: silicone defoamer (Wacker)

Marlox MO 124: C₁₂₋₁₄ fatty alcohol ethoxylate/propoxylate+2 mol EO and 4 mol PO (Condea)

Marlinat 242/90 M: C₁₂₋₁₄ fatty alcohol polyethylene glycol (2EO) ether sulfate monoisopropanolamine salt (Condea)

Edenor K 12-18: C₁₂₋₁₈ fatty acid (Cognis)

The measured viscosity values of the formulations indicated in Table 1 show that, with one exception, the preparations obtained are pseudoplastic and exhibit shear-diluting behavior.

### Comparison Example

A SwissCaps gelatin ball equivalent to Examples 1 to 7 above was filled with a conventional free-flowing laundry detergent formulation. The formulation is shown in Table 2 below. Viscosity was again determined by the Brookfield method.

TABLE 2

| | |
|---|---|
| Marlox MO 124 | 33 |
| Marlinat 242/90M | 40 |
| Edenor K12-18 | 5 |
| Monoethanolamine | 6 |
| Polyethylene glycol 400 | 14 |
| Hydroxyethanediphosphonic acid | 1 |
| Perfume | 1 |
| Viscosity in mPa · s | |
| 20 r.p.m. | 258 |
| Compression resistance at 23° C. (in N) | 69.4 |

The compression resistance of the filled gelatin balls of Examples 1 to 7 and the Comparison Example was measured by the method described above. The results show that the stability of balls filed with non-newtonian or relatively high-viscosity liquids was greater than that of balls filled with a free-flowing product.

1. A laundry detergent, dishwashing detergent or cleaner portion comprising a completely or partly water-soluble envelope in the form of a capsule, which completely surrounds a liquid-based formulation of at least one washing-, dishwashing- or cleaning-active material, with a compression resistance of >1 N at 23° C.

2. A laundry detergent, dishwashing detergent or cleaner portion comprising a completely or partly water-soluble envelope in the form of a ball, which completely surrounds a liquid-based formulation of at least one washing-, dishwashing- or cleaning-active material, with a compression resistance of >1 N at 23° C.

3. A laundry detergent, dishwashing detergent or cleaner portion comprising a completely or partly water-soluble envelope in the form of a bag, which completely surrounds a liquid-based formulation of at least one washing-, dishwashing- or cleaning-active material, with a compression resistance of >1 N at 23° C.

4. A laundry detergent, dishwashing detergent or cleaner portion as claimed in any of claims 1 to 3, in which the compression resistance is in the range from 1 to 10⁶ N, preferably in the range from 10 to 10⁵ N, more preferably in the range from 10² to 10⁴ N and most preferably in the range from 200 to 5,000 N, as measured at 23° C.

5. A laundry detergent, dishwashing detergent or cleaner portion as claimed in any of claims 1 to 4 comprising a completely or partly water-soluble envelope of a material from the group consisting of (optionally partly acetalized) polyvinyl alcohol, polyvinyl pyrrolidone, polyethylene oxide, gelatin, cellulose and derivatives thereof, starch and derivatives thereof, blends and composites, inorganic salts and mixtures of the materials mentioned.

6. A laundry detergent, dishwashing detergent or cleaner portion as claimed in any of claims 1 to 5 comprising a completely water-soluble envelope from the group consisting of capsules of gelatin, preferably soft gelatin, bags of (optionally partly acetalized) polyvinyl alcohol, balls of (optionally partly acetalized) polyvinyl alcohol or gelatin, preferably soft gelatin, or an inorganic salt or a mixture of inorganic salts.

7. A laundry detergent, dishwashing detergent or cleaner portion as claimed in claim 5 or claim 6, in which the water-soluble envelope comprises poorly water-soluble or completely water-insoluble regions or regions which only dissolve in water at elevated temperature and readily water-soluble regions or regions which dissolve in water at low temperatures.

8. A laundry detergent, dishwashing detergent or cleaner portion as claimed in claim 7, in which the poorly water-soluble or completely water-insoluble regions of the envelope or the regions which only dissolve in water at elevated temperature consist of a material which, chemically, substantially corresponds to that of the readily water-soluble regions or the regions which dissolve in water at relatively low temperatures, but which has a greater layer thickness and/or a modified degree of polymerization and/or a higher degree of crosslinking and/or a higher degree of acetalization and/or a content of water-insoluble salt components and/or a content of water-insoluble polymers.

9. A laundry detergent, dishwashing detergent or cleaner portion as claimed in any of claims 1 to 8, in which the completely or partly water-soluble envelope contains one or more incorporated washing-, dishwashing or cleaning-active components, more particularly components which are only present in small quantities in laundry detergents, dishwashing detergents or cleaners.

10. A laundry detergent, dishwashing detergent or cleaner portion as claimed in any of claims 1 to 9, in which the liquid-based formulation of at least one washing-, dishwashing- or cleaning-active material is a low-water formulation.

11. A laundry detergent, dishwashing detergent or cleaner portion as claimed in any of claims 1 to 10, in which the low-water formulation comprises a thickening system.

12. A laundry detergent, dishwashing detergent or cleaner portion as claimed in claim 11, in which the low-water formulation comprises a polymeric thickener and optionally other components contributing towards thickening as the thickening system.

13. A laundry detergent, dishwashing detergent or cleaner portion as claimed in any of claims 1 to 9, in which the liquid-based formulation of at least one washing, dishwashing- or cleaning-active material is a nonaqueous or substantially water-free formulation, preferably a formulation containing less than 5% by weight of water, more preferably a formulation containing 1 to 3% by weight of water and most preferably a formulation containing no water.

14. A laundry detergent, dishwashing detergent or cleaner portion as claimed in any of claims 1 to 9 and 13, in which the nonaqueous or substantially water-free formulation is a formulation containing anionic surfactant and/or nonionic surfactant.

15. A laundry detergent, dishwashing detergent or cleaner portion as claimed in any of claims 1 to 9, 13 and 14, in which the anionic surfactant(s) is/are selected from the group of sulfonates and sulfates and mixtures thereof and/or in which the nonionic surfactant(s) is/are selected from the group of alkoxylated alcohols, alkoxylated fatty acid alkyl esters, alkyl glycosides and mixtures thereof.

16. A laundry detergent, dishwashing detergent or cleaner portion as claimed in any of claims 1 to 15, in which the liquid-based formulations show non-newtonian flow behavior, preferably thixotropic or pseudoplastic flow behavior.

17. A laundry detergent, dishwashing detergent or cleaner portion as claimed in any of claims 1 to 16, in which the liquid-based formulations have a low viscosity during production and thereafter undergo an increase in viscosity of at least 10%, preferably of at least 50% and more preferably of at least 100%.

18. A process for the production of a laundry detergent, dishwashing detergent or cleaner portion comprising a completely or partly water-soluble envelope in the form of a capsule, ball or bag which in turn completely surrounds a liquid-based formulation of at least one washing-, dishwashing- or cleaning-active material, characterized in that it comprises the steps of
(a) initially introducing at least one liquid component of the liquid-based formulation of at least one washing-, dishwashing- or cleaning-active material and agitating it by application of a certain shear rate;
(b) optionally adding one or more other liquid component(s) of the liquid-based formulation;
(c) optionally incorporating one or more solid component(s) of the liquid-based formulation in the liquid phase thus prepared and then optionally adding one or more other solid and/or liquid component(s) while maintaining a certain shear rate; and
(d) optionally introducing the liquid mixture prepared in step (c) immediately into the envelope and closing the envelope around the liquid-based formation.

19. A process as claimed in claim 18, in which the liquid mixture prepared in step (c) is introduced belatedly into the envelope which is then closed around the liquid-based formulation.

20. A laundry washing process, more particularly a process for washing laundry in a commercially available washing machine, characterized in that it comprises the steps of
(a) introducing a laundry detergent portion as claimed in any of claims 1 to 17 into the washing machine, more particularly into the dispensing compartment or into the washing drum;
(b) establishing contact between the laundry detergent portion and the wash liquor through the addition of water;
(c) establishing the required washing conditions and
(d) with the required conditions in place, releasing the washing-active material(s) of the laundry detergent portion into the wash liquor and bringing it/them into contact with the laundry to be washed.

21. A dishwashing process, more particularly a process for machine dishwashing in a commercially available dishwashing machine, characterized in that it comprises the steps of
(a) introducing a dishwashing detergent portion as claimed in any of claims 1 to 17 into the dishwashing machine, more particularly into the dispensing compartment or into the tank;
(b) establishing contact between the dishwashing detergent portion and the wash liquor through the addition of water;
(c) establishing the required dishwashing conditions and
(d) with the required conditions in place, releasing the dishwashing-active material(s) of the dishwashing detergent portion into the wash liquor and bringing it/them into contact with the tableware to be cleaned.

22. A cleaning process, characterized in that it comprises the steps of
(a) introducing a cleaner portion as claimed in any of claims 1 to 17 into the cleaning liquor,
(b) establishing the required cleaning cleaning conditions and
(c) with these conditions in place, releasing the cleaning-active material(s) of the cleaner portion into the cleaning liquor and bringing it/them into contact with the item(s) to be cleaned.
